(19) United States
(12) Patent Application Publication
(10) Pub. No.: US 2005/0015244 A1
(43) Pub. Date: Jan. 20, 2005

(54) Speech section detection apparatus

(76) Inventors: Hideki Kitao, Kobe-shi (JP); Osamu Iwata, Kobe-shi (JP); Masataka Nakamura, Hiroshima (JP); Kazuya Terao, Tokyo (JP); Satomi Kodama, Hiroshima (JP)

Correspondence Address: CHRISTIE, PARKER & HALE, LLP, PO BOX 7068, PASADENA, CA, 91109-7068, US

(21) Appl. No.: 10/619,874

(22) Filed: Jul. 14, 2003

(51) Int. Cl. G10L 21/00

(52) U.S. Cl. 704/226

(57) ABSTRACT

A speech section detection apparatus capable of reliably detecting a speech section even in the case of a speech signal with low signal-to-noise ratio. The speech signal collected by a microphone and amplified by a line amplifier is converted by an A/D converter into a digital value, which is then stored in a memory. After removing noise from the digitized speech signal, the signal-to-noise ratio is improved by taking short-time auto-correlation and, when the signal level has continued to stay above a threshold value for a predetermined period, it is determined that a speech section has been detected. Further, a prescribed period before and after the thus determined speech section is also forcefully set as a target for extraction so that the beginning and end of the speech section can be reliably detected. Furthermore, to prevent noise from accumulating and causing the threshold value to increase excessively, the threshold value is updated as appropriate by multiplying a moving average taken over a prescribed period in a non-speech section by a predetermined factor, and by setting the resulting product as the threshold value.

### BACKGROUND OF THE INVENTION

1. Field of the Invention

The present invention relates to a speech section detection apparatus and, more particularly, to a speech section detection apparatus capable of reliably detecting a speech section even in the case of a speech signal with low signal-to-noise ratio.

2. Description of the Related Art

In speech recognition, speech sections, based on which speech is recognized must be accurately extracted from a noise-containing signal captured through a microphone. The prior art has generally employed a speech section detection method that determines the detection of a speech section when a speech level larger than a predetermined threshold has continued for more than a predetermined length of time but, with this method, it has been difficult to achieve sufficient accuracy for systems designed to recognize a large variety of words spoken by unspecified speakers.

To solve this problem, the applicant has previously proposed in Japanese Unexamined Patent Publication No. 2002-091470 a speech section detection apparatus that detects a speech section based on a speech pitch signal.

Indeed, the speech section detection apparatus based on speech pitch can detect a speech section reliably even for a word containing a glottal stop sound or for a word containing a succession of “s” column sounds (sounds belonging to the third column in the Japanese Goju-on Zu syllabary table) or “h” column sounds (sounds belonging to the sixth column in the same table), but when the speech level of the speaker is low, for example, when the speaker is a female, since a sufficient signal-to-noise ratio cannot be secured at the beginning or the end of a speech section, speech pitch cannot be extracted and it is therefore difficult to detect the speech section.

### SUMMARY OF THE INVENTION

The present invention has been devised in view of the above problem, and it is an object of the invention to provide a speech section detection apparatus capable of reliably detecting a speech section even in the case of a speech signal with low signal-to-noise ratio.

A speech section detection apparatus according to the present invention comprises: preprocessing means for removing noise contained in a speech signal; signal-to-noise ratio improving means for improving the signal-to-noise ratio of the speech signal from which noise has been removed by the preprocessing means; and speech section extracting signal generating means for generating a speech section extracting signal based on the speech signal whose signal-to-noise ratio has been improved by the signal-to-noise ratio improving means. In this apparatus, after removing the noise, the speech section extracting signal is generated based on the speech signal with improved signal-to-noise ratio.

In one preferred mode of the invention, the signal-to-noise ratio improving means is a short-time auto-correlation value calculating means for calculating a short-time auto-correlation value of the speech signal from which noise has been removed by the preprocessing means.

In another preferred mode of the invention, the speech section extracting signal is set open when the short-time auto-correlation value calculated by the short-time auto-correlation value calculating means has continued to stay above a predetermined threshold value for a predetermined length of time.

In another preferred mode of the invention, the speech section extracting signal generating means includes threshold value setting means for setting, as the threshold value, the product between an average level of the speech signal when the speech section extracting signal is in a closed state and a predetermined factor.

In another preferred mode of the invention, the speech section extracting signal generating means comprises: extracting signal opening means for setting the extracting signal open when the level of the short-time auto-correlation value calculated by the short-time auto-correlation value calculating means has continued to stay above a predetermined threshold value for a predetermined length of time; and extracting signal retroactively opening means for outputting the speech section extracting signal by setting the extracting signal open retroactively over a predetermined period when the extracting signal has been set open by the extracting signal opening means.

In another preferred mode of the invention, the speech section extracting signal generating means comprises: extracting signal opening means for setting the extracting signal open when the short-time auto-correlation value calculated by the short-time auto-correlation value calculating means has continued to stay above a predetermined threshold value for a predetermined length of time; and extracting signal open state maintaining means for outputting the speech section extracting signal by maintaining the extracting signal in an open state for a predetermined period, even after the extracting signal is closed, when the extracting signal has been set open by the extracting signal opening means.

### BRIEF DESCRIPTION OF THE DRAWINGS

The features and advantages of the present invention will be apparent from the following description with reference to the accompanying drawings, in which:

FIG. 1 is a diagram showing the configuration of a speech section detection apparatus according to the present invention;

FIG. 2 is a flowchart of a main routine;

FIG. 3 is a flowchart of an initial value setting routine;

FIG. 4 is a flowchart of a speech signal processing routine;

FIG. 5 is a flowchart of a short-time auto-correction routine;

FIGS. 6A, 6B, and 6C are diagrams for explaining the effectiveness of the short-time auto-correction process;

FIG. 7 is a flowchart of a root mean squaring routine;

FIGS. 8A, 8B, and 8C are diagrams for explaining the effectiveness of smoothing;

FIG. 9 is a flowchart of a gate routine;

FIG. 10 is a flowchart of a gate open/close routine;

FIG. 11 is a flowchart of a threshold value setting routine;

FIGS. 12A and 12B are diagrams for explaining a speech section and a non-speech section;

FIG. 13 is a flowchart of a shift routine;

FIG. 14 is a flowchart of a speech section extracting signal generation routine;

FIG. 15 is a flowchart of a basic extracting signal generation routine;

FIG. 16 is a flowchart of a gate opening routine;

FIG. 17 is a flowchart of a forward extending routine;

FIG. 18 is a flowchart of a forward extending processing routine;

FIG. 19 is a flowchart of a backward extending routine;

FIG. 20 is a flowchart of an open state maintaining routine;

FIG. 21 is a flowchart of an open state halfway maintaining routine;

FIGS. 22A and 22B are diagrams for explaining the effectiveness of the forward extending and backward extending processes; and

FIGS. 23A, 23B, 23C, 23D, 23E, 23F, 23G, and 23H are diagrams for explaining the process of speech signal processing in the speech section detection apparatus according to the present invention.

### DESCRIPTION OF THE PREFERRED EMBODIMENTS

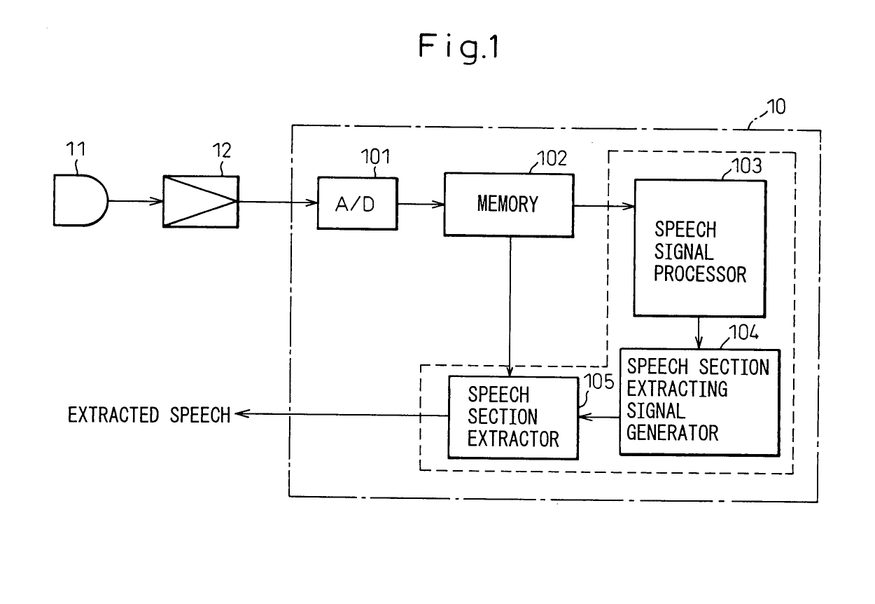

FIG. 1 is a diagram showing the functional configuration of a speech section detection apparatus according to the present invention. A speech signal converted by a microphone 11 into an electrical signal and amplified by a line amplifier 12 is fed into the speech section detection apparatus 10. The speech section detection apparatus 10 comprises an analog/digital (A/D) converter 101, a memory 102, a speech signal processor 103, a speech section extracting signal generator 104, and a speech section extractor 105.

That is, the speech signal is sampled by the A/D converter 101 at every predetermined sampling time of T seconds, and stored in the memory 102. The speech section extracting signal generator 104 generates a speech section extracting signal based on an output of the speech signal processor 103. Based on this speech section extracting signal, the speech section extractor 105 extracts a speech section from the digitized speech signal stored in the memory 102.

In the present embodiment, the A/D converter 101, the memory 102, the speech signal processor 103, the speech section extracting signal generator 104, and the speech section extractor 105 are constructed using a personal computer (PC). In particular, the speech signal processor 103, the speech section extracting signal generator 104, and the speech section extractor 105 are implemented in software, and are made to function as a speech section detector by installing a program on the PC.

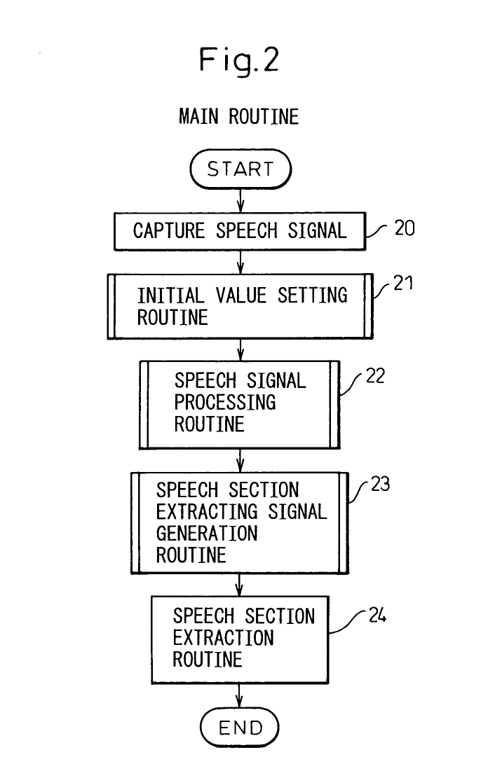

FIG. 2 is a flowchart illustrating the main routine of the program which is recorded on a recording medium such as a CD-ROM and is installed on the PC. In step 20, the speech signal to be processed is sampled by the A/D converter 101 at every predetermined sampling time, and stored in the memory 102. The sampling time can be determined as appropriate; the present embodiment assumes the sampling time T=0.08333 milliseconds (sampling frequency=12 kHz).

In step 21, an initial value setting routine for initializing parameters used in the speech processing is executed; in step 22, a speech signal processing routine for improving the signal-to-noise ratio of the speech signal is executed; and in step 23, a speech section extracting signal generation routine for generating the speech section extracting signal, based on the speech signal with improved signal-to-noise ratio, is executed. Finally, a speech section extraction routine for extracting, based on the speech section extracting signal, a speech section from the speech signal stored in the memory 102 is executed in step 24, and the main routine is terminated.

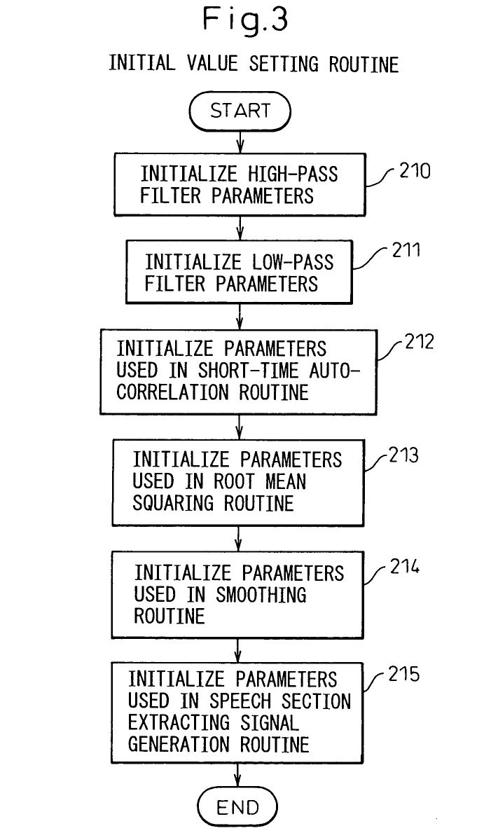

FIG. 3 is a flowchart illustrating the initial value setting routine to be executed in step 21. First, in step 210, high-pass filter parameters used in the speech signal processing routine are initialized in accordance with the following equations.
ω_{CH}=2·π·f_{CH}
α=tan(ω_{CH}·T)
H=1/(1+2α+2α²+α³)
A=H·(3α³−2α+2α²−3)
B=H·(3α³−2α−2α²+3)
C=H·(α³+2α−2α²−1)
where f_{CH} is the cut-off frequency of the high-pass filter, and T is the sampling time (seconds).

Next, in step 211, low-pass filter parameters are set in accordance with the following equation.
ω_{CL}=2·π·f_{CL}
where f_{CL} is the cut-off frequency of the low-pass filter.

After that, parameters used in a short-time auto-correlation routine and parameters used in a root mean squaring routine are initialized in steps 212 and 213, respectively.

Next, in step 214, parameters used in a smoothing routine are initialized in accordance with the following equations.
a=exp(−1/2·ω_{CS}/f_{CS})·{−cos(√3/2·ω_{CS}/f_{CS})+√3/3·sin(√3/2·ω_{CS}/f_{CS})}+exp(−ω_{CS}/f_{CS})
b=exp(−3/2·ω_{CS}/f_{CS})·{−cos(√3/2·ω_{CS}/f_{CS})+√3/3·sin(√3/2·ω_{CS}/f_{CS})}+exp(−ω_{CS}/f_{CS})
c=−2·exp(−1/2·ω_{CS}/f_{CS})·cos(√3/2·ω_{CS}/f_{CS})−exp(−ω_{CS}/f_{CS})
d=2·exp(−3/2·ω_{CS}/f_{CS})·cos(√3/2·ω_{CS}/f_{CS})+exp(−ω_{CS}/f_{CS})
e=−exp(−1/2·ω_{CS}/f_{CS})
h=|[(1+c+d+e)/{ω_{CS}·(a+b)}]|
aa=√2·exp(−√2/2·ω_{CS}/f_{CS})·sin(√2/2·ω_{CS}/f_{CS})
bb=−2·exp(−√2/2·ω_{CS}/f_{CS})·cos(√2/2·ω_{CS}/f_{CS})
cc=exp(−√2/2·ω_{CS}/f_{CS})
hh=|{(1+bb+cc)/(wc·aa)}]|
A=a·aa
B=b·bb
D=cc+c·bb+d
E=c·cc+d·bb+e
F=d·cc+e·bb
G=e·cc
H=h·hh
ω_{CS}=2·π·f_{CS}
where f_{CS} is the cut-off frequency of the smoothing filter.

Further, parameters used in the speech section extracting signal generation routine are initialized in step 215, and the routine illustrated here is terminated.

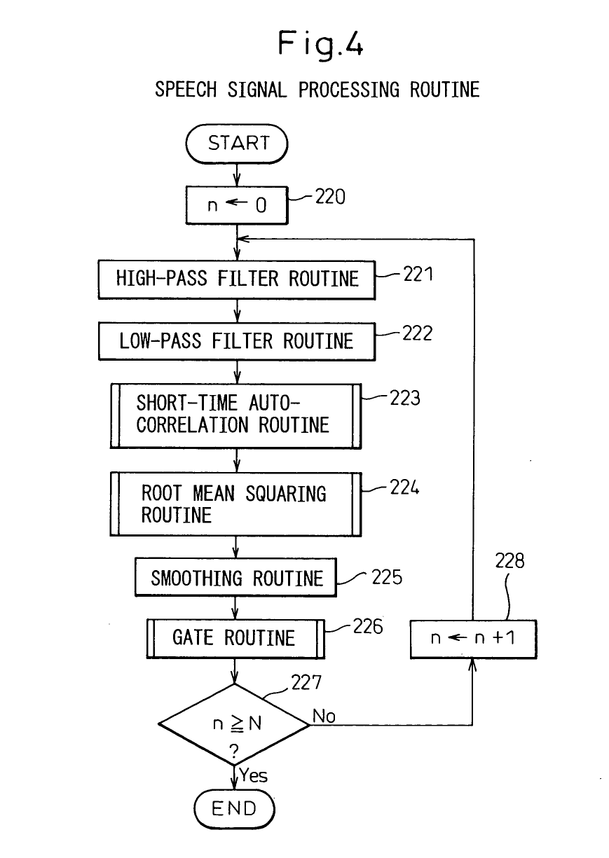

FIG. 4 is a flowchart illustrating the speech signal processing routine which is executed in step 22 within the main routine. First, in step 220, a parameter n indicating the sampling point is initialized to “0”. In step 221, using the high-pass filter parameters set in step 210 of the initial value setting routine, a high-pass filter routine based on the following equation is executed on the speech signal X_{I}(n) stored in the memory 102, to output a high-pass filtering signal X_{H}(n).
X_{H}(n)=H·{X_{I}(n)−3X_{I}(n−1)+3X_{I}(n−2)−X_{I}(n−3)}−{A·X_{H}(n−1)+B·X_{H}(n−2)+C·X_{H}(n−3)}
where X_{I}(n) is the speech signal at the sampling point n, and X_{H}(n) is the high-pass filter output at the sampling point n.

This processing is performed to remove air-conditioner noise radiated within a vehicle, and the cut-off frequency f_{CH} of the high-pass filter is chosen to be, for example, 300 hertz.

Next, in step 222, using the low-pass filter parameters set in step 211 of the initial value setting routine, a low-pass filter routine based on the following equation is executed on the high-pass filter output signal X_{H}(n), to output a low-pass filtering signal X_{L}(n).
X_{L}(n)=X_{H}(n)+exp(−ω_{CL}/f_{CL})·X_{H}(n−1)+exp(−2ω_{CL}/f_{CL})·X_{H}(n−2)+exp(−3ω_{CL}/f_{CL})·X_{H}(n−3)
where X_{H}(n) is the high-pass filter output at the sampling point n, and X_{L}(n) is the low-pass filter output at the sampling point n.

This processing is performed to remove abruptly occurring high-frequency noise, and the cut-off frequency f_{CL} of the low-pass filter is chosen to be, for example, 3000 hertz.

Then, in step 223, to improve the signal-to-noise ratio, the short-time auto-correlation routine is executed on the low-pass filter output signal X_{L}(n) to calculate a short-time auto-correlation signal X_{C}(n).

Next, in step 224, the root-means-square value X_{P}(n) of the short-time auto-correlation signal X_{C}(n) is calculated, and in step 225, the root-means-square value X_{P}(n) is smoothed by a low-pass filter to calculate the smoothed output X_{S}(n). Further, in step 226, a gate routine is executed on the smoothed output X_{S}(n) to calculate a gate signal G(n).

Then, in step 227, it is determined whether the calculation of the gate signal G has been completed for N speech signals X_{I}; if the answer is No, the parameter n is incremented in step 228, and the process from step 221 onward is repeated. On the other hand, if the answer in step 227 is Yes, that is, when the speech signal processing is completed for the N speech signals X_{I}, the routine illustrated here is terminated. The processing performed in steps 223 to 226 will be described in detail below.

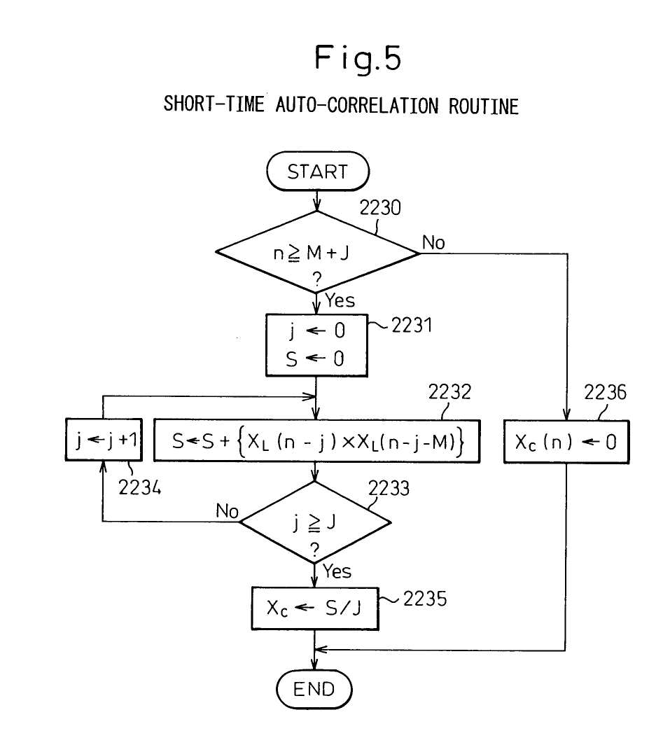

FIG. 5 is a flowchart illustrating the short-time auto-correlation routine which is executed in step 223 within the speech signal processing routine. In this routine, the signal level in a speech section is increased relative to the noise level in a non-speech section by calculating, based on the following equation, correlation values for a number, J, of correlated samples between the low-pass filtered speech signal X_{L}(n) and the low-pass filtered speech signal X_{L}(n-M) separated from it by a predetermined number, M, of independent samples.

$${X}_{c} = \frac{1}{J} {\sum }_{j = 0}^{J} {X}_{L} ( n - j ) \times {X}_{L} ( n - j - M )$$

where
X_{C}=short-time auto-correlation value
X_{L}=low-pass filter output
n=sampling number
J=number of correlated samples
M=number of independent samples

First, in step 2230, it is determined whether the present sampling point n is either equal to or larger than the sum of the number, M, of independent samples and the number, J, of correlated samples. The values of the number M and the number J are set in step 212 of the initial value setting routine.

If the answer in step 2230 is Yes, that is, if the present sampling point n is either equal to or larger than the sum of the number, M, of independent samples and the number, J, of correlated samples, which means that calculation of the auto-correlation is possible, then the process proceeds to step 2231 where a parameter j indicating the number of additions and the cumulative value S are both initialized to “0”, and in step 2232, the sum of S and the product of X_{L}(n-j) and X_{L}(n-j-M) is now set as S.

Then, in step 2233, it is determined whether the parameter j is either equal to or larger than the number, J, of correlated samples. If the answer is No, that is, if the parameter j is smaller than the number, J, of correlated samples, the parameter j is incremented in step 2234, and the processing in step 2232 is repeated.

If the answer in step 2233 is Yes, that is, if the parameter j is either equal to or larger than the number, J, of correlated samples, the process proceeds to step 2235 where the short-time auto-correlation signal X_{C}(n) is calculated by dividing the cumulative value S by the number, J, of correlated samples, after which the routine is terminated.

On the other hand, if the answer in step 2230 is No, that is, if the present sampling point n is smaller than the sum of the number, M, of independent samples and the number, J, of correlated samples, calculation of the auto-correlation is not possible; therefore, the short-time auto-correlation signal X_{C}(n) is set to “0” in step 2236, and the routine is terminated.

Here, the number, M, of independent samples and the number, J, of correlated samples must be determined by experiment so that the speech section can be detected accurately, irrespective of the speaker, and it is desirable that the number, J, of correlated samples be set to 5, and that the number, M, of independent samples be set so that the separating time corresponds to 3 milliseconds (for example, when the sampling time is 0.08333 milliseconds, M should be set to 36).

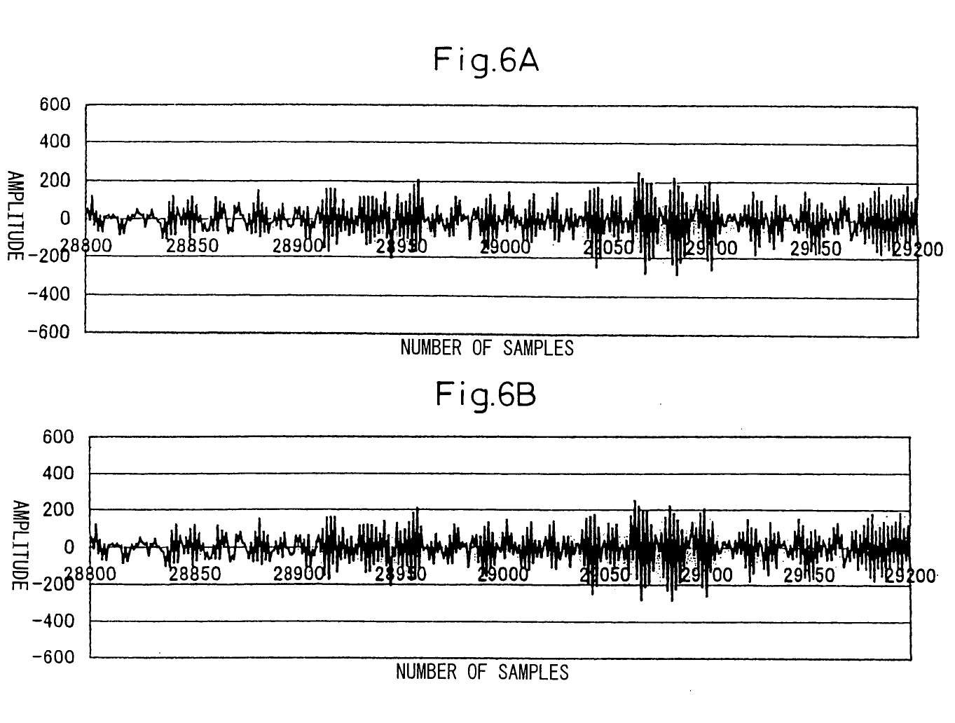

FIGS. 6A, 6B, and 6C are diagrams for explaining the effectiveness of the short-time auto-correlation process. FIG. 6A shows the low-pass filtered signal X_{L}(n), FIG. 6B shows the speech signal waveform produced by shifting the waveform of FIG. 6A by the separating time (=3 milliseconds), and FIG. 6C shows the waveform of the short-time auto-correlation signal X_{C}(n). From these figures, it can be seen that the signal-to-noise ratio improves when the short-time auto-correlation is applied.

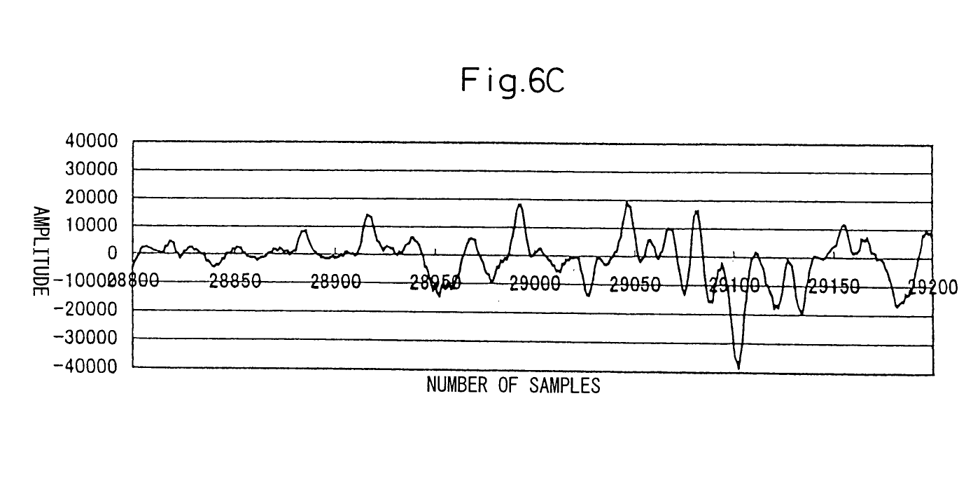

FIG. 7 is a flowchart illustrating the root mean squaring routine which is executed in step 224 within the speech signal processing routine. In this routine, root mean squaring is applied to the short-time auto-correlation signal X_{C}(n) in order to eliminate the influence in the amplitude direction of the short-time auto-correlated signal X_{C}.

First, in step 2240, it is determined whether the present sampling number n is smaller than a predetermined number N_{P} (for example, 200). If the answer is Yes, then the root mean squared signal X_{P}(n) is set to “01 in step 2241, and the routine is terminated. This is to remove noise contained in the starting portion of the short-time auto-correlation signal X_{C}(n).

If the answer in step 2240 is No, that is, if the beginning portion has already been excluded, the process proceeds to step 2242 to determine whether a parameter k has reached a predetermined value K (for example, 32); if the answer is No, then in step 2243 the sum of S and the square of X_{C}(n) is now set as S. Next, in step 2244, the root mean squared signal X_{P}(n) is set to a holding signal X_{PO}, and the parameter k is incremented, after which the routine is terminated.

If the answer in step 2242 is Yes, that is, if the parameter k has reached the predetermined value K, then in step 2245 the square root of the value obtained by dividing the cumulative value S by J is obtained to calculate the root mean squared signal X_{P}(n), and the holding output X_{PO} is set to the root mean squared signal X_{P}(n). Then, in step 2246, the parameters S and k are reset, and the routine is terminated.

When the root mean squaring process is completed, the smoothing process is performed in step 225 of the speech signal processing routine by using a fifth-order low-pass IIR filter expressed by the following equation, in order to remove high-frequency components (in particular, impulse components) contained in the root mean squared signal X_{P}.
X_{S}(n)←H·ω_{CS}²·{A·X_{P}(n−1)+B·X_{P}(n−2)}−{C·X_{S}(n−1)+D·X_{S}(n−2)+E·X_{S}(n−3)+F·X_{S}(n−4)+G·X_{S}(n−5)}

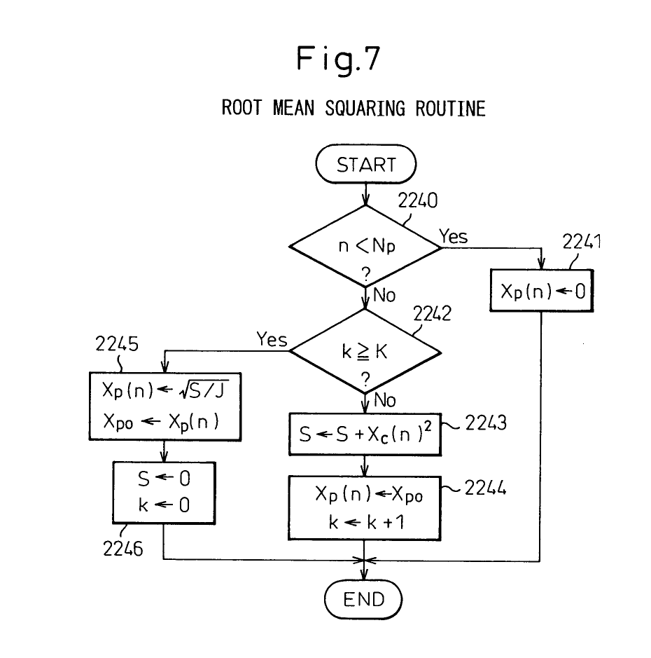

FIGS. 8A, 8B, and 8C are diagrams for explaining the effectiveness of the smoothing process. As can be seen, when the root mean squaring is applied to the short-time auto-correlation signal X_{C}(n) shown in FIG. 8A, the resulting root mean squared signal X_{P}(n) shown in FIG. 8B contains a significant amount of high-frequency component. When the smoothing is applied here, the smoothed signal X_{S}(n) shown in FIG. 8C is smooth as shown, and this makes it easier to determine the threshold value.

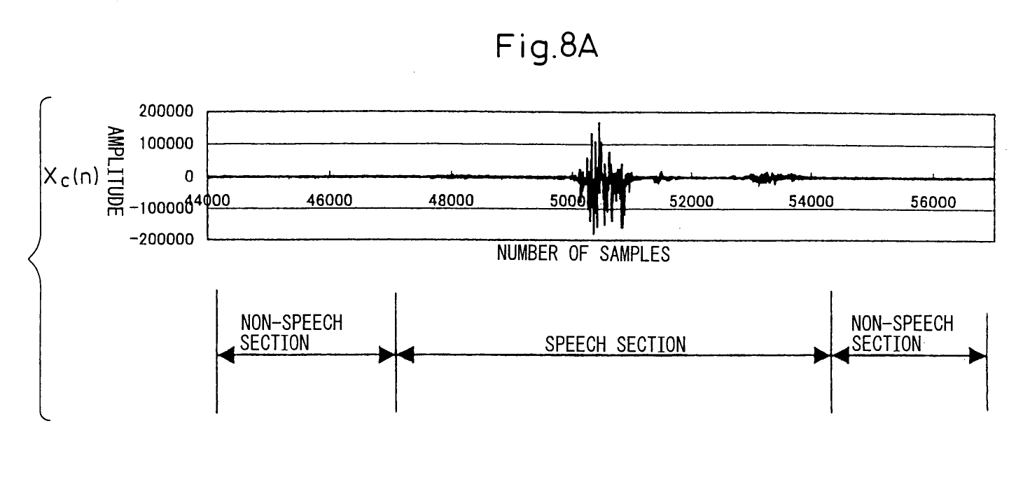

FIG. 9 is a flowchart illustrating the gate routine which is executed in step 226 within the speech signal processing routine. A gate open/close routine and a threshold value setting routine are executed in steps 2260 and 2261, respectively.

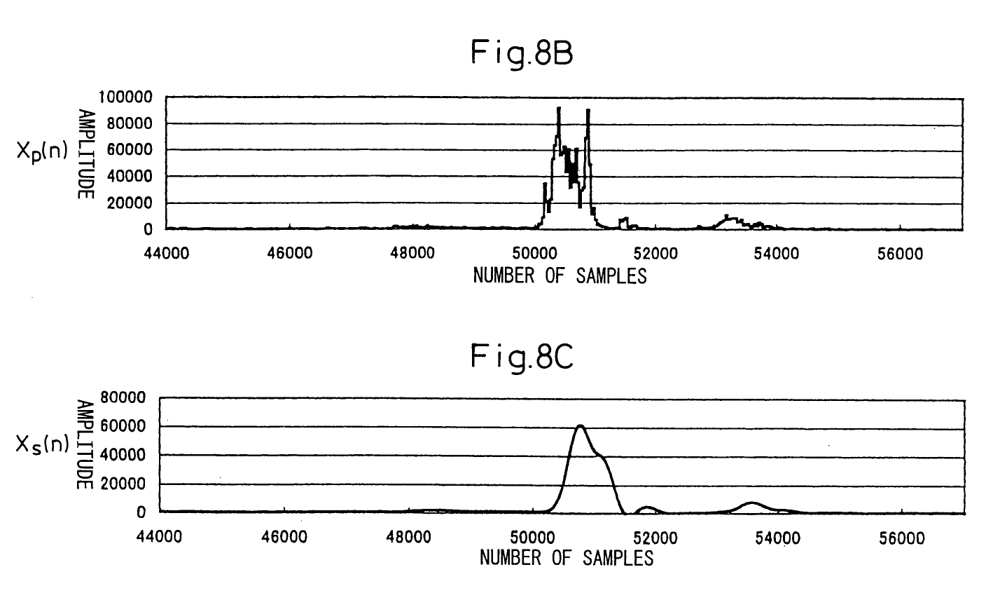

FIG. 10 is a flowchart illustrating the gate open/close routine which is executed in step 2260 within the gate routine. First, in step 60a, the threshold value TL is set equal to the noise level ZL(n−1) one sample back multiplied by a predetermined value TR (for example, 1.8). Next, in step 60b, it is determined whether the smoothed signal X_{S}(n) is either equal to or smaller than the threshold value TL. Here, when n=0, the value of the noise level one sample back is initialized to “0” in step 215 of the initial value setting routine.

If the answer in step 60b is Yes, that is, if the smoothed signal X_{S}(n) is either equal to or smaller than the threshold value TL, then in step 60c the gate signal G(n) at the present sampling point is set to “0” (closed), and the routine is terminated. On the other hand, if the answer in step 60b is No, that is, if the smoothed signal X_{S}(n) is larger than the threshold value TL, the gate signal G(n) at the present sampling point is set to “1” (open) in step 60d, and the routine is terminated.

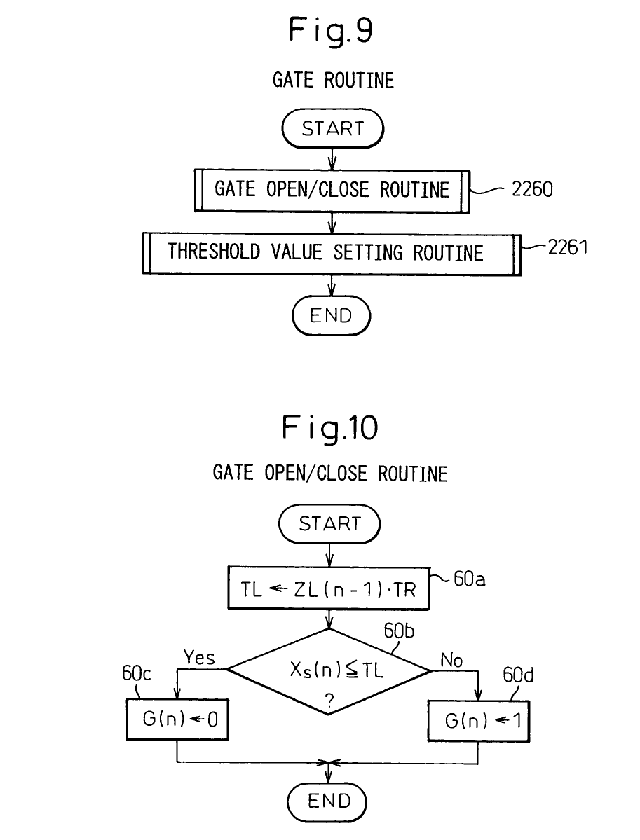

FIG. 11 is a flowchart illustrating the threshold value setting routine which is executed in step 2261 within the gate routine. In this routine, the threshold value is automatically updated, considering the fact that the speech level varies from one speaker to another and, therefore, that if the threshold value were fixed, speaker-independent detection of a speech section would become difficult.

More specifically, the average value of the root mean squared signals X_{P} in a non-speech section where no speech is present is taken as the noise level, and the threshold value is set equal to the noise level multiplied by a predetermined value. However, if the number of samples over which to take the average value were not limited here, the threshold value might be held high because of the effect of high-level noise that occurred a great many samples back; therefore, the number of root mean squared signals X_{P} over which to take the average value is limited to a predetermined number M (for example, 1200).

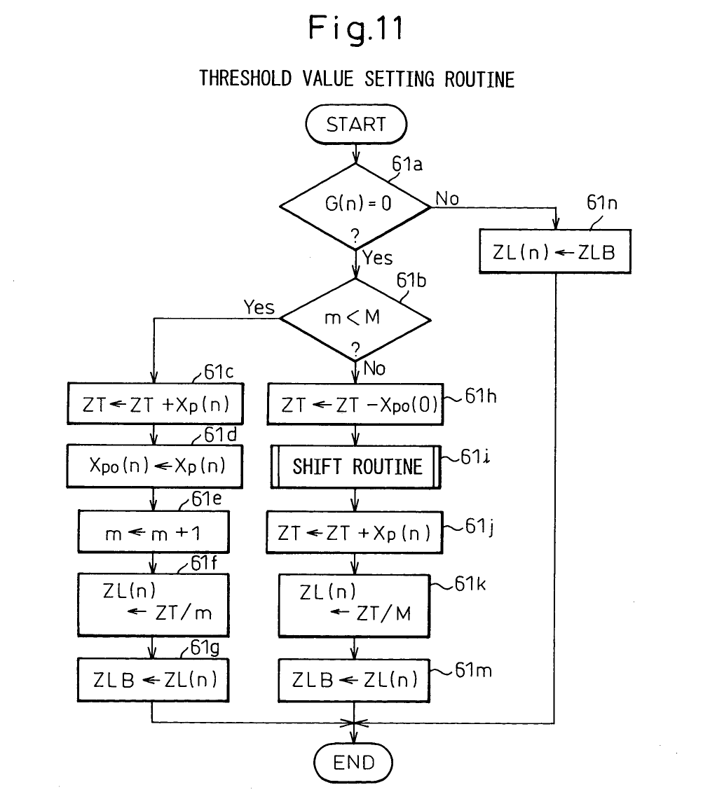

FIGS. 12A and 12B are diagrams for explaining the distinction between a speech section and a non-speech section. In the speech signal shown in FIG. 12A, the section (section “b”) where the root mean squared signal X_{P} is larger than the threshold value is determined as a speech section, and the sections (sections “a” and “c”) where the root mean squared signal X_{P} is smaller than the threshold value are each determined as a non-speech section. The gate signal G(n) shown in FIG. 12B is open in section “b”.

In step 61a of FIG. 11, it is determined whether the gate signal G(n) is “0” or not; if the answer is Yes, that is, if no speech is present, then in step 61b it is determined whether a parameter m is smaller than the predetermined number M over which to calculate the noise level.

If the answer in step 61b is Yes, that is, if the parameter m is smaller than the predetermined value M, the noise cumulative value ZT is updated in step 61c by adding the root mean squared signal X_{P}(n) to the noise cumulative value ZT.

Next, in step 61d, the root mean squared signal X_{P}(n) is held at the root mean squared signal holding signal X_{PO}(n), and in step 61e, the parameter m is incremented. Then, in step 61f, the noise cumulative value ZT divided by m is set as the noise level ZL(n), and in step 61g, the noise level holding value ZLB is updated with the present noise level ZL(n), after which the routine is terminated. The processing in step 61g is performed to prepare for the case where the gate signal G(n+1) of the next sampling number goes to “1”.

On the other hand, if the answer in step 61b is No, that is, if the parameter m is not smaller than the predetermined value M, then in step 61h the root mean squared signal holding signal X_{PO}(0) is subtracted from the noise cumulative value ZT. This processing is performed to keep ZT as the cumulative value for 1199 samples by removing X_{PO}(0), the oldest root mean squared signal holding signal X_{PO}, before updating the noise cumulative value ZT, because the number of samples over which to take the average value is limited to 1200.

Next, in step 61i, shifting is performed to shift the root mean squared signal holding signal X_{PO} forward by one; the details of the shifting will be described later.

In step 61j, the noise cumulative value ZT is updated by adding the present root mean squared signal X_{P}(n) to the noise cumulative value ZT and thus setting the number of additions to M, and in step 61k, the noise cumulative value ZT divided by the predetermined value M is set as the noise level ZL(n). Then, in step 61m, the noise level holding value ZLB is updated with the present noise level ZL(n), and the routine is terminated.

On the other hand, if the answer in step 61a is No, that is, if the present section is a speech section, then the noise level holding value ZLB, i.e., the noise level calculated in the immediately preceding non-speech section, is taken as the present noise level ZL(n) in step 61n, after which the routine is terminated.

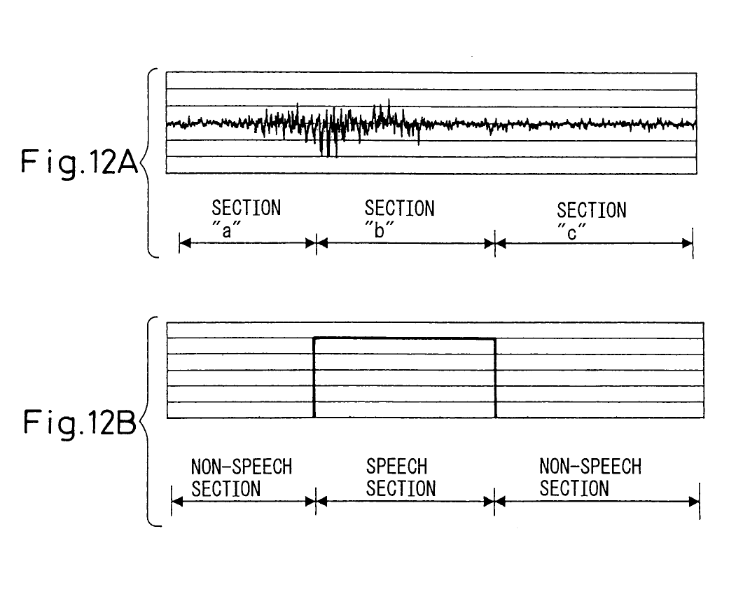

FIG. 13 is a flowchart illustrating the shift routine which is executed in step 61i within the threshold value setting routine. In step 6110, a parameter m_{P} is initialized to “0” and, in step 61i1, the root mean squared signal holding signal X_{PO} is shifted forward by setting the root mean squared signal holding signal X_{PO}(mₚ+1) as X_{PO}(mₚ). In step 61i2, it is determined whether the parameter mₚ is smaller than “M−1”; if the answer is Yes, the parameter mₚ is incremented in step 61i3, and the processing in step 61i1 is repeated.

On the other hand, if the answer in step 61i2 is No, that is, if the parameter mₚ has reached “M−1”, then the present root mean squared signal X_{P}(n) is held as the (M−1)th root mean squared signal holding signal X_{PO}(M−1) in step 61i4, after which the routine is terminated.

When the speech signal processing routine in step 22 of the main routine is thus terminated, the main routine proceeds to step 23 to execute the speech section extracting signal generation routine.

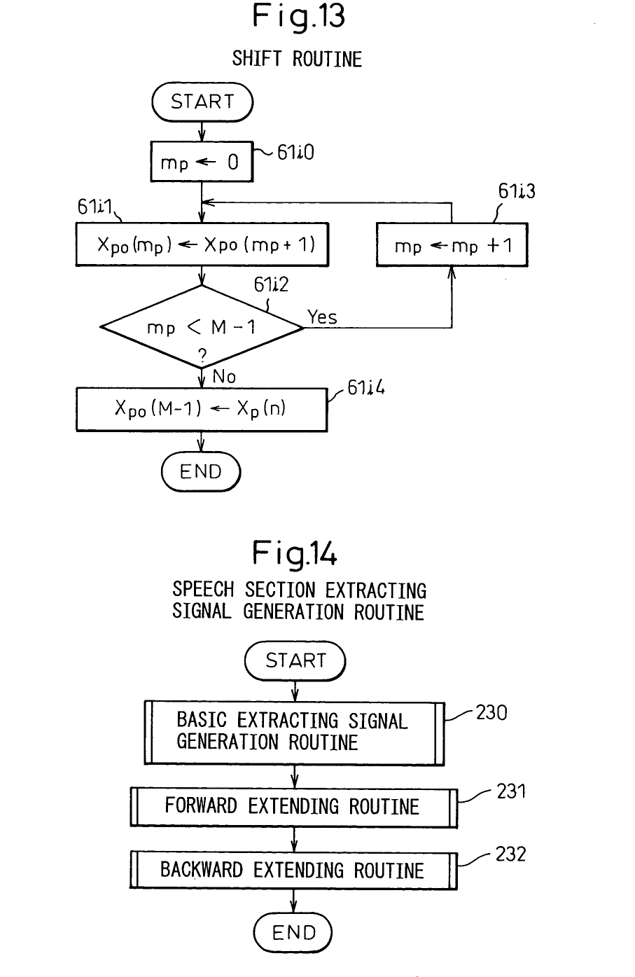

FIG. 14 is a flowchart illustrating the speech section extracting signal generation routine which is executed in step 23 within the main routine. A basic extracting signal generation routine for generating a basic extracting signal for the extraction of a speech section is executed in step 230, a forward extending routine for retroactively setting the basic extracting signal in an open state is executed in step 231, and a backward extending routine for maintaining the open state for a predetermined length of time after the basic extracting signal is closed is executed in step 232.

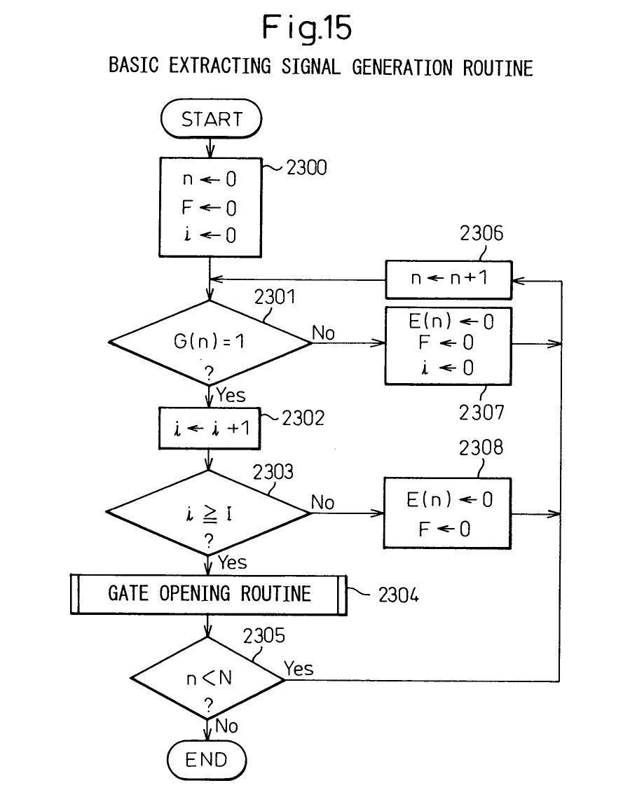

FIG. 15 is a flowchart illustrating the basic extracting signal generation routine which is executed in step 230 within the speech section extracting signal generation routine. In this routine, when the gate opened in the gate open/close routine has remained open continuously for a predetermined length of time, it is determined that a basic speech section has been detected.

First, in step 2300, the parameters n (the parameter indicating the sampling point), F (the flag indicating whether the gate opening process has already been executed or not), and i (the parameter counting the number of sampling points during the open state) used in this routine are reset.

Next, in step 2301, it is determined whether the gate signal G(n) set in the gate open/close routine is “1” (open) or not; if the answer is Yes, the parameter i is incremented in step 2302.

In step 2303, it is determined whether the parameter i has reached a predetermined number I (for example, 480). The number I corresponds to the length of time during which the gate signal G(n) is maintained in the “1” (open) state, and which is long enough to determine that a speech section has been entered; here, when the length of time is 40 milliseconds, and the sampling time is 0.08333 milliseconds, the number I is 480.

If the answer in step 2303 is Yes, that is, if the open state of the gate signal G(n) has continued for the time corresponding to the predetermined number I, then the gate opening routine is executed in step 2304, the details of which will be described later.

When the gate opening routine is completed, it is determined in step 2305 whether the parameter n is smaller than the total number of sampling points, N. If the answer is Yes, that is, if the processing is not yet completed for all the sampling points, the parameter n is incremented in step 2306, and the process from step 2301 to step 2304 is repeated. On the other hand, if the answer in step 2305 is Yes, that is, if the processing is completed for all the sampling points, the routine is terminated.

If the answer in step 2301 is No, that is, if the gate signal G(n) is “0” (closed), then the extracting signal E(n) is set to zero, while also resetting the parameters F and i, and the process proceeds to step 2306.

If the answer in step 2303 is No, that is, if the number i indicating the length of time that the gate signal G(n) is maintained in the open state is smaller than the predetermined number I, then the extracting signal E(n) is set to zero, while also resetting the parameter F, and the process proceeds to step 2306.

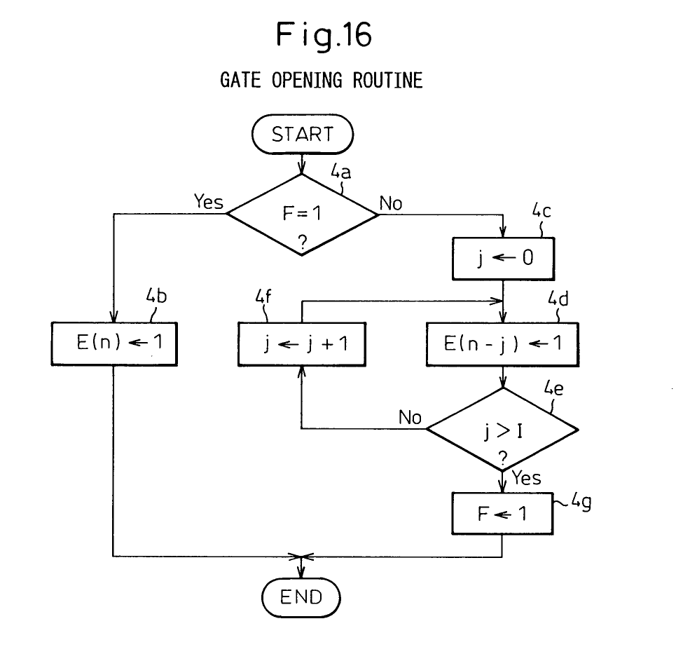

FIG. 16 is a flowchart illustrating the gate opening routine which is executed in step 2304 within the basic extracting signal generation routine. First, in step 4a, it is determined whether the flag F is “1” or not. If the answer in step 4a is Yes, that is, if the gate opening process is already completed, the present extracting signal E(n) is set to “1” in step 4b, and the routine is terminated.

On the other hand, if the answer in step 4a is No, that is, if the gate opening process is not yet completed, it is determined that the gate signal G(n) is in the “1” state but that the state has not continued for the length of time corresponding to the number I, and the routine proceeds to perform the gate opening steps 4c to 4g in which the extracting signal E that has been set to “0” is retroactively set to “1”.

More specifically, in step 4c, the parameter j indicating the number of retroactive samples is reset, and in step 4d, the extracting signal E(n−j) j samples back from the present point is set to “1”. Next, in step 4e, it is determined whether the parameter j is larger than the predetermined number I; if the answer is No, that is, if the retroactive process is not yet completed, the parameter j is incremented in step 4f, and the process returns to step 4d.

On the other hand, if the answer in step 4e is Yes, that is, if the retroactive process is completed for the predetermined number of samplings, the flag F is set to “1” in step 4g, and the routine is terminated.

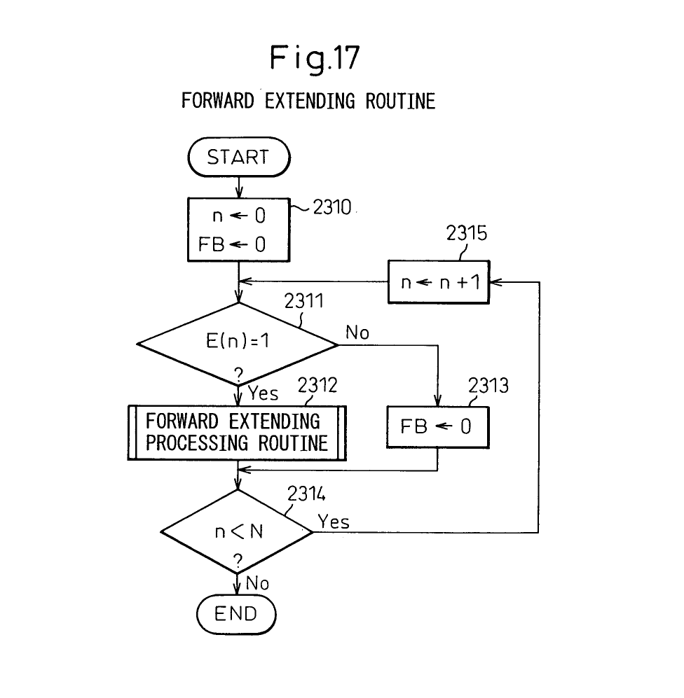

FIG. 17 is a flowchart illustrating the forward extending routine which is executed in step 231 within the speech section extracting signal generation routine. In this routine, considering the fact that the speech level is generally low at the beginning of speech, the extracting signal E is extended forward retroactively over a predetermined period in order to reliably detect the beginning of a speech section.

That is, in step 2310, the parameters n (the parameter indicting the sampling point) and FB (the flag indicating whether the forward extending process has already been executed or not) used in this routine are reset.

Next, in step 2311, it is determined whether the extracting signal E(n) is “1” (open) or not; if the answer is Yes, a forward extending processing routine is executed in step 2312, and the process proceeds to step 2314. On the other hand, if the answer in step 2311 is No, that is, if the extracting signal E(n) is “0” (closed), the flag FB is set to “0” in step 2313 and the process proceeds to step 2314.

In step 2314, it is determined whether the parameter n is smaller than the total number of sampling points, N; if the answer is Yes, that is, if the processing is not yet completed for all the sampling points, the parameter n is incremented in step 2315, and the process returns to step 2311. On the other hand, if the answer in step 2314 is No, that is, if the processing is completed for all the sampling points, the routine is terminated.

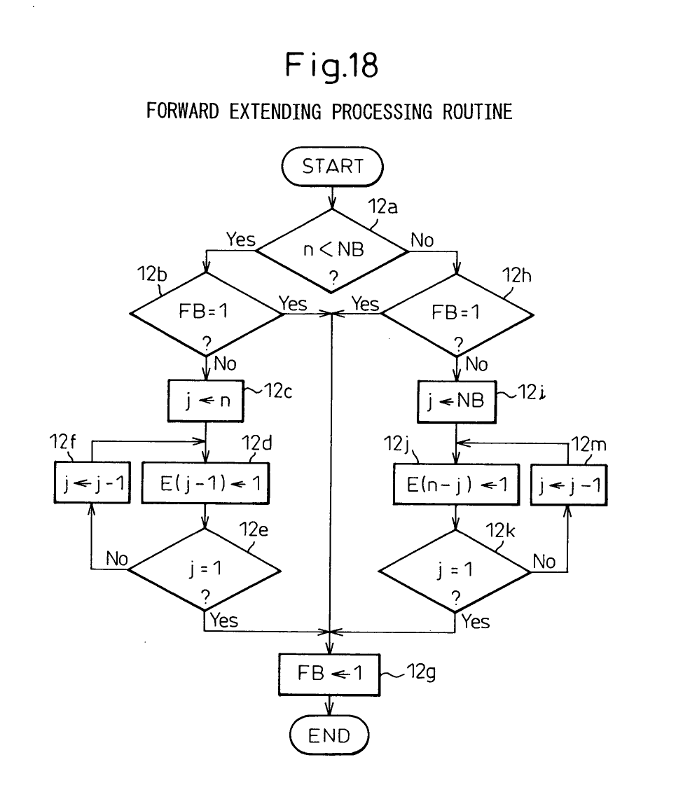

FIG. 18 is a flowchart illustrating the forward extending processing routine which is executed in step 2312 within the forward extending routine. First, in step 12a, it is determined whether the present sampling point n is smaller than the number of samples, NB, which corresponds to the period over which the basic extracting signal should be extended forward (for example, 50 milliseconds).

If the answer in step 12a is Yes, that is, if the starting extracting signal E(0) to the extracting signal E(n−1) one sample back from the present point are to be set to “1”, the process proceeds to step 12b. In step 12b, it is determined whether the forward extending process has already been executed or not, that is, whether the flag FB is “1” or not; if the answer is No, the parameter j indicating the number of retroactive samples is set to n in step 12c.

Then, in step 12d, the extracting signal E(j−1) is set to “1”, and in step 12e, it is determined whether the parameter j is equal to “1” or not. If the answer in step 12e is No, the parameter j is decremented in step 12f, and the processing in step 12d is repeated. On the other hand, if the answer in step 12e is Yes, it is determined that the forward extending process is completed, and the flag FB is set to “1” in step 12g, after which the routine is terminated.

If the answer in step 12a is No, that is, if the extracting signal E(n−NB) to the extracting signal E(n−1) one sample back from the present point are to be set to “1”, the process proceeds to step 12h. In step 12h, it is determined whether the forward extending process has already been executed or not, that is, whether the flag FB is “1” or not; if the answer is No, the parameter j indicating the number of retroactive samples is set to NB in step 12i.

Then, in step 12j, the extracting signal E(n−j) is set to “1”, and in step 12k, it is determined whether the parameter j is equal to “1” or not. If the answer in step 12k is No, the parameter j is decremented in step 12m, and the processing in step 12j is repeated. On the other hand, if the answer in step 12k is Yes, it is determined that the forward extending process is completed, and the flag FB is set to 11” in step 12g, after which the routine is terminated.

On the other hand, if the answer in step 12b or 12h is Yes, that is, if the forward extending process is already completed, the value “1” of the present extracting signal E(n) is maintained, and the flag FB is set to “1” in step 12g, after which the routine is terminated.

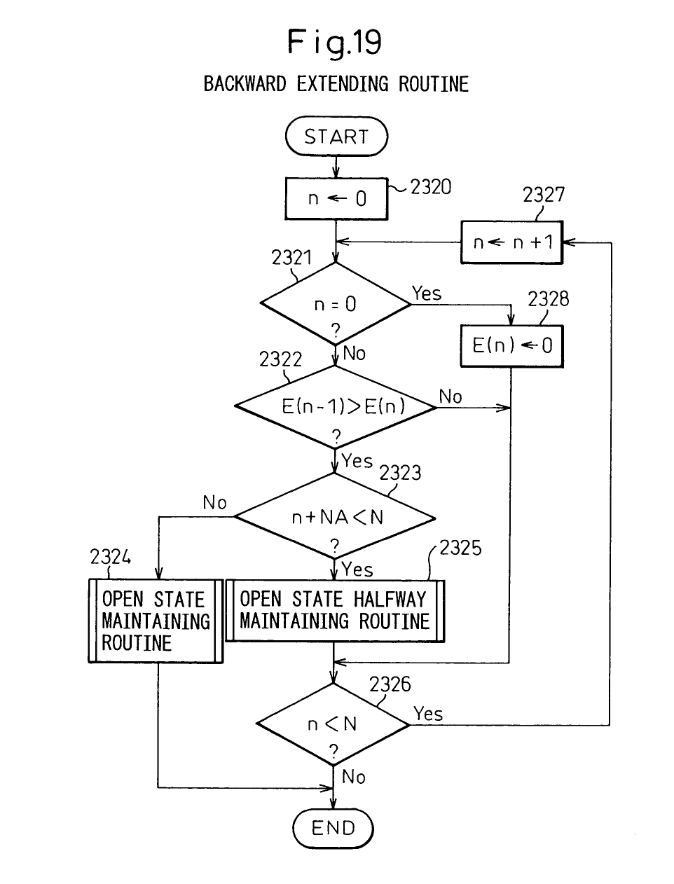

FIG. 19 is a flowchart illustrating the backward extending routine which is executed in step 232 within the speech section extracting signal generation routine. In this routine, considering the fact that the speech level is generally low at the end of speech, the extracting signal E is extended backward over a prescribed period in order to reliably detect the end of a speech section.

First, in step 2320, the parameter n (the parameter indicating the sampling point) used in this routine is set to “0”. Next, in step 2321, it is determined whether the parameter n is “0” or not. If the answer in step 2321 is No, that is, if a sampling point other than the starting sampling point is to be processed, then it is determined in step 2322 whether the previous extracting signal E(n−1) is larger than the present extracting signal E(n).

If the answer in step 2322 is Yes, that is, if the extracting signal E has changed from “1” (open) to “0” (closed), it is determined in step 2323 whether the sum of the parameter n and a predetermined number NA is smaller than the total number of samples, N. Here, NA is the number of samples corresponding to the period over which the extracting signal should be extended backward; for example, when this period is 100 milliseconds, and the sampling time is 0.08333 milliseconds, then NA=1200.

If the answer in step 2323 is No, that is, if the number of samples over which to extend backward exceeds the total number of samples, an open state maintaining routine is executed in step 2324 to set the extracting signals from E(n) to E(N) to “1” (open), after which the routine illustrated here is terminated.

On the other hand, if the answer in step 2323 is Yes, that is, if the number of samples over which to extend backward does not exceed the total number of samples, an open state halfway maintaining routine is executed in step 2325 to set the extracting signals from E(n) to E(n+NA) to “1” (open), after which the process proceeds to step 2326.

In step 2326, it is determined whether the parameter n is smaller than the total number of sampling points, N. If the answer is Yes, that is, if the processing is not yet completed for all the sampling points, the parameter n is incremented in step 2327, and the processing from step 2321 onward is repeated.

On the other hand, if the answer in step 2321 is Yes, that is, if the starting data is to be processed, the extracting signal E(n) is set to “0” in step 2328, and the process proceeds to step 2326. If the answer in step 2322 is No, that is, in cases other than the case where the extracting signal E has changed from “1” (open) to “0” (closed), no particular processing is performed except to maintain the value of the present extracting signal E(n), and the process proceeds directly to step 2326.

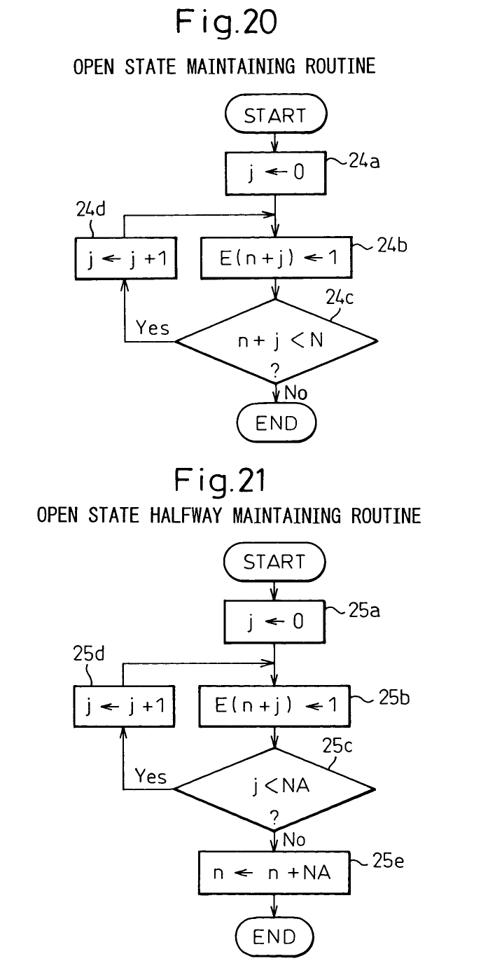

FIG. 20 is a flowchart illustrating the open state maintaining routine which is executed in step 2324 within the backward extending routine. In step 24a, the parameter j is reset, and in step 24b, the extracting signal E(n+j) is set to “1” (open). Next, in step 24c, it is determined whether n+j is smaller than the total number of samples, N; if the answer is Yes, that is, if all extracting signals up to the final extracting signal E(N) have not yet been set to “1” (open), the parameter j is incremented in step 24d, and the process returns to step 24b. On the other hand, if the answer in step 24c is No, that is, if all extracting signals up to the final extracting signal E(N) have been set to “1” (open), the routine is terminated.

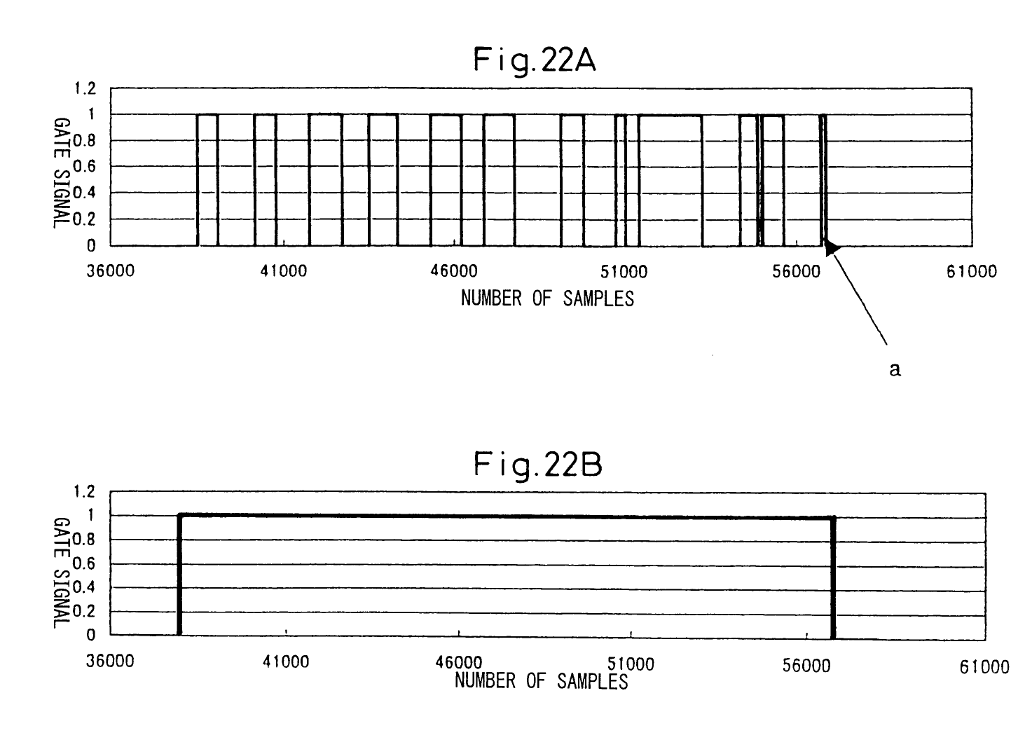

FIG. 21 is a flowchart illustrating the open state halfway maintaining routine which is executed in step 2325 within the backward extending routine. In step 25a, the parameter j is reset, and in step 25b, the extracting signal E(n+j) is set to “1” (open). Next, in step 25c, it is determined whether j is smaller than the predetermined number NA; if the answer is Yes, that is, if all the NA extracting signals E have not yet been set to “1” (open), the parameter j is incremented in step 25d, and the process returns to step 25b. On the other hand, if the answer in step 25c is No, that is, if all the NA extracting signals E have been set to “1” (open), the parameter n is incremented by NA in step 25e, and the routine is terminated.

In this way, the speech section extracting signal generation routine in the main routine is completed, and the speech section extracting signal E is generated.

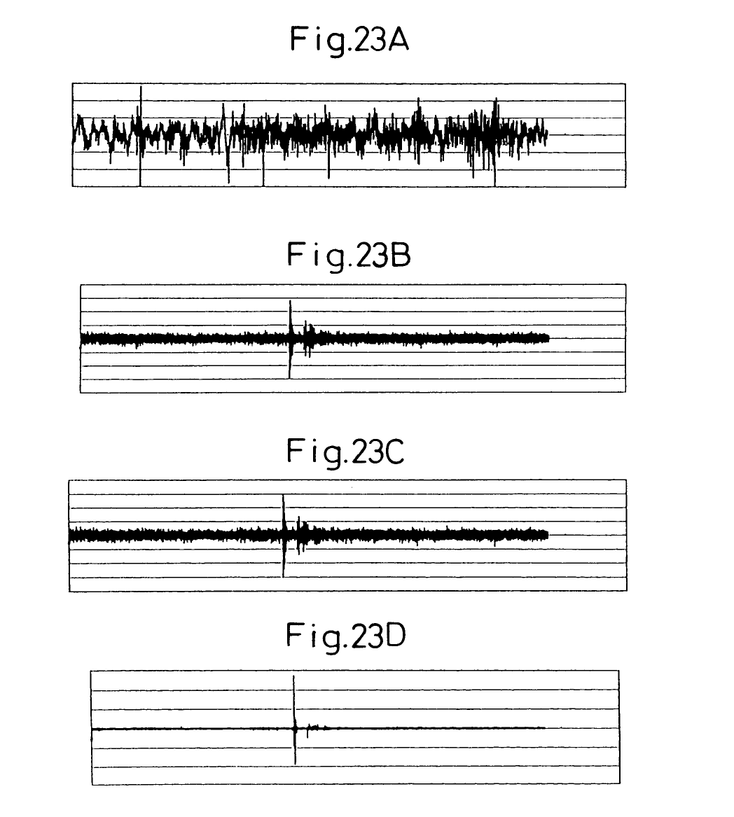

FIGS. 22A and 22B are diagrams for explaining the effectiveness of the forward extending and backward extending processes. If the opening/closing of the gate is determined based on a comparison between the root mean squared signal X_{P} and the threshold value, the gate signal G will be repetitively opened and closed, as shown in FIG. 22A; as a result, the speech section cannot be extracted accurately.

On the other hand, when the forward extending and backward extending processes are applied to the gate signal G, as explained above, the speech section extracting signal remains open, as shown in FIG. 22B, throughout the period from the 37446th sampling point to the 57591st sampling point during which speech is present. Here, “a” in FIG. 22A is not included in the speech section extracting signal because, at “a”, the open duration time of the gate signal G is not longer than 40 milliseconds.

Finally, in step 24 of the main routine, by adding up the speech signal X_{I}(n) stored in the memory and the extracting signal E(n) in synchronizing fashion, it becomes possible to extract the speech signal X_{I} in the section where the extracting signal E is “1” (open).

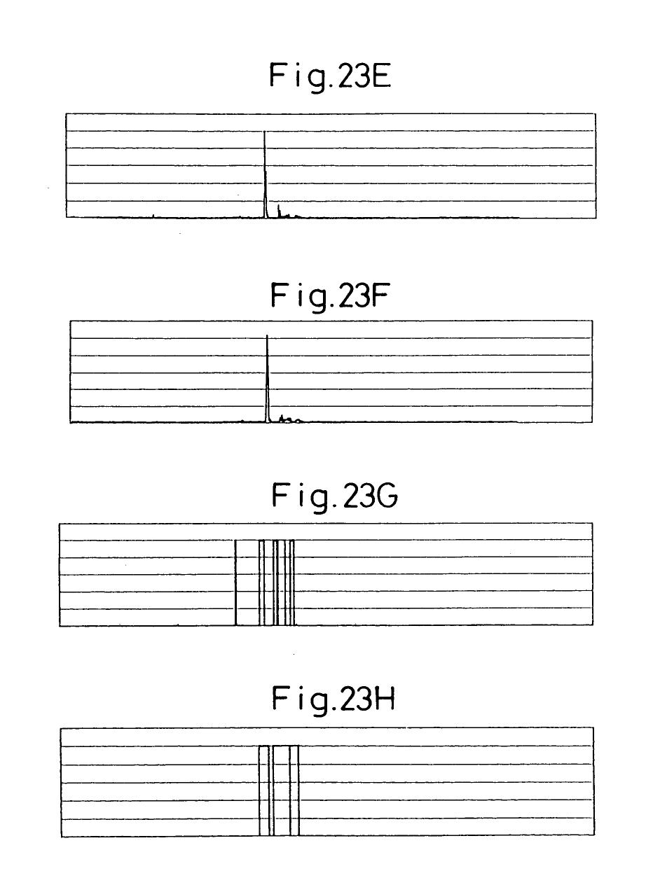

FIGS. 23A, 23B, 23C, 23D, 23E, 23F, 23G, and 23H are diagrams for explaining the process of speech signal processing in the speech section detection apparatus according to the present invention. FIG. 23A shows the waveform of an unprocessed signal X_{I}(n) representing the word “ice cream” pronounced by a female inside an automobile, FIG. 23B shows the waveform of the high-pass filtered signal X_{H}(n), FIG. 23C shows the waveform of the low-pass filtered signal X_{L}(n), and FIG. 23D shows the waveform of the short-time auto-correlation signal X_{C}(n).

Further, FIG. 23E shows the waveform of the root mean squared signal X_{P}(n), FIG. 23F shows the waveform of the smoothed signal X_{S}(n), FIG. 23G shows the waveform of the gate signal G(n), and FIG. 23H shows the waveform of the speech section extracting signal E(n). The extracted speech section can be fed to a succeeding apparatus, such as a speech recognition apparatus, and be used to improve the speech recognition rate.

As described above, according to the present invention, as the speech section extracting signal is generated based on the speech signal with improved signal-to-noise ratio, the speech section can be detected reliably even in an environment where the signal-to-noise ratio is poor. Further, according to the present invention, the signal-to-noise ratio of the speech signal can be improved using the short-time auto-correlation value of the speech signal.

According to the present invention, when the level of the short-time auto-correlation value has stayed above a predetermined threshold value continuously for a predetermined length of time, the speech section extracting signal is set open; this makes it possible to reliably detect the speech section even in an environment where the signal-to-noise ratio is poor. Further, according to the present invention, the threshold value can be updated as appropriate.

According to the present invention, as the speech section extracting signal is generated by setting the extracting signal open retroactively over a predetermined period, the beginning of the speech section can be detected reliably. Further, according to the present invention, as the speech section extracting signal is generated by maintaining the extracting signal in an open state for a predetermined period after the extracting signal is closed, the end of the speech section can be detected reliably.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

1. A speech section detection apparatus comprising:
preprocessing means for removing noise contained in a speech signal;
signal-to-noise ratio improving means for improving the signal-to-noise ratio of said speech signal from which noise has been removed by said preprocessing means; and
speech section extracting signal generating means for generating a speech section extracting signal based on said speech signal whose signal-to-noise ratio has been improved by said signal-to-noise improving means.

2. A speech section detection apparatus as claimed in claim 1, wherein said signal-to-noise ratio improving means is a short-time auto-correlation value calculating means for calculating a short-time auto-correlation value of said speech signal from which noise has been removed by said preprocessing means, in accordance with the equation
$${X}_{c} = \frac{1}{J} {\sum }_{j = 0}^{J} {X}_{L} ( n - j ) \times {X}_{L} ( n - j - M )$$
where
X_{C}=short-time auto-correlation value
X_{L}=low-pass filter output
n=sampling number
J=number of correlated samples
M=number of independent samples.

3. A speech section detection apparatus as claimed in claim 1, wherein said preprocessing means comprises:
a high-pass filter for cutting off low-frequency noise contained in said speech signal; and
a low-pass filter for cutting off high-frequency noise contained in said speech signal.

4. A speech section detection apparatus as claimed in claim 1, wherein said speech section extracting signal generating means sets said speech section extracting signal open when the level of said speech signal whose signal-to-noise ratio has been improved by said signal-to-noise ratio improving means has continued to stay above a predetermined threshold value for a predetermined length of time.

5. A speech section detection apparatus as claimed in claim 2, wherein said speech section extracting signal generating means sets said speech section extracting signal open when the level of said short-time auto-correlation value calculated by said short-time auto-correlation value calculating means has continued to stay above a predetermined threshold value for a predetermined length of time.

6. A speech section detection apparatus as claimed in claim 4 or 5, wherein said speech section extracting signal generating means includes threshold value setting means for setting as said threshold value the product between an average level of said speech signal when said speech section extracting signal is in a closed state and a predetermined factor.

7. A speech section detection apparatus as claimed in claim 5, wherein said speech section extracting signal generating means includes:
root-mean-square value calculating means for calculating a root-mean-square value of said short-time auto-correlation value calculated by said short-time auto-correlation value calculating means;
smoothing means for smoothing the root-mean-square value of said short-time auto-correlation value, calculated by said root-mean-square value calculating means; and
threshold value setting means for setting, as said threshold value, the product between the root-mean-square value of said short-time auto-correlation value smoothed by said smoothing means when said speech section extracting signal is in a closed state and a predetermined factor.

8. A speech section detection apparatus as claimed in claim 2, wherein said speech section extracting signal generating means comprises:
extracting signal opening means for setting said extracting signal open when said short-time auto-correlation value calculated by said short-time auto-correlation value calculating means has continued to stay above a predetermined threshold value for a predetermined length of time; and
extracting signal retroactively opening means for outputting said speech section extracting signal by setting said extracting signal open retroactively over a predetermined period when said extracting signal has been set open by said extracting signal opening means.

9. A speech section detection apparatus as claimed in claim 2, wherein said speech section extracting signal generating means comprises:
extracting signal opening means for setting said extracting signal open when said short-time auto-correlation value calculated by said short-time auto-correlation value calculating means has continued to stay above a predetermined threshold value for a predetermined length of time; and
extracting signal open state maintaining means for outputting said speech section extracting signal by maintaining said extracting signal in an open state for a predetermined period, even after said extracting signal is closed, when said extracting signal has been set open by said extracting signal opening means.

10. A speech section detection apparatus as claimed in claim 2, wherein said speech section extracting signal generating means comprises:
extracting signal opening means for setting said extracting signal open when said short-time auto-correlation value calculated by said short-time auto-correlation value calculating means has continued to stay above a predetermined threshold value for a predetermined length of time;
extracting signal retroactively opening means for setting said extracting signal open retroactively over a predetermined period when said extracting signal has been set open by said extracting signal opening means; and
extracting signal open state maintaining means for outputting said speech section extracting signal by maintaining said extracting signal in an open state for a predetermined period, even after said retroactively opened extracting signal is closed, when said extracting signal has been set open retroactively by said retroactively opening means.
